(19) United States
(12) Patent Application Publication
(10) Pub. No.: US 2009/0230715 A1
(43) Pub. Date: Sep. 17, 2009

(54) Windshield for a Vehicle and a Vehicle Comprising Same

(76) Inventor: Freddy Brinkhorst, Hengelo (NL)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/574,537

(22) PCT Filed: Sep. 2, 2004
(86) PCT No.: PCT/EP04/09818

§ 371 Date: Jun. 7, 2007

(51) Int. Cl. B60J 1/02; B62J 17/04

(52) U.S. Cl. 296/96.21; 296/78.1

(57) ABSTRACT

The invention relates to a windshield for a vehicle, such as a motorbike or bicycle, comprising a frame (8) connectable to said vehicle (1), which frame carries a shield (2) comprising a number of shield elements (7) foldably mounted to the frame (8). The invention also relates to a vehicle (1), such as a motorbike or bicycle comprising such windshield connected thereto.

The present invention relates to a windshield for a vehicle, such as a motorbike or bicycle, and to a vehicle comprising such a windshield.

A vehicle such as a motorbike or bicycle is provided with a windshield in order to protect the driver of the vehicle against windy or rainy conditions and against flying objects when riding with the vehicle. Under particular conditions, such as riding the vehicle at low speed, the windshield serves no particular important function. Furthermore, when parking or storing the vehicle, the windshield is vulnerable and may be subject to damage

It is an object of the present invention to provide a transparent, preferably plastic windshield for a vehicle which substantially overcomes the afore mentioned disadvantages. Accordingly, the windshield for a vehicle such as a mountainbike or a bicycle according to the invention comprising a frame connectable to said vehicle, which frame carries a shield comprising a number of shield elements foldably mounted to the frame. Accordingly, when the windshield serves its function for shielding the driver of the vehicle, the shield is formed by folding out the shield elements thereby forming the windshield. When the shielding function is no longer required, the driver removes or collapses the windshield by folding in the shield elements.

An elegant manner of folding in or out the windshield is by rotation. To that extent it is preferred that the rotatable shield elements are mounted on a common rotation shaft. In the folded in mode, the windshield resides normally below the hand handles bars of the vehicle, thereby providing a non obstructed free view for the driver. According to one preferred embodiment the rotatable shield elements when folding in or out the windshield rotates in the same rotational direction. According to another preferred embodiment the rotatable shield elements when folding in or out the windshield rotates in reverse rotational directions towards one another. In this preferred embodiment in the folded in mode shield elements reside at both sides of the vehicle which provides a more balanced appearance and riding properties of the vehicle.

According to another preferred embodiment the windshields comprises a motor connected to the rotational shaft for folding in or out the windshield elements. Accordingly, by actuating the motor via a switch the windshield is folded in or out in a very convenient manner, such as while maintaining the hands on the handles.

In order to adjust the windshield to a particular vehicle or driver it is preferred that it comprises means for adjusting the height dimension of the windshield relative to the vehicle.

According to another preferred embodiment the windshield is provided with a headlight. Accordingly, the vehicle may be provided with an additional headlight or a traditional headlight mounted to the vehicle frame may be avoided.

The windshield according to the invention may have a very aesthetic appearance when preferably the windshield has the form of a circle.

Finally, the present invention further relates to a vehicle such as a motorbike or bicycle provided with the windshield according to the invention.

Hereafter, a windshield and vehicle according to the invention will be further defined and described by way of two embodiments without limiting the invention thereto, while making reference to the annexed drawings. In the drawings are:

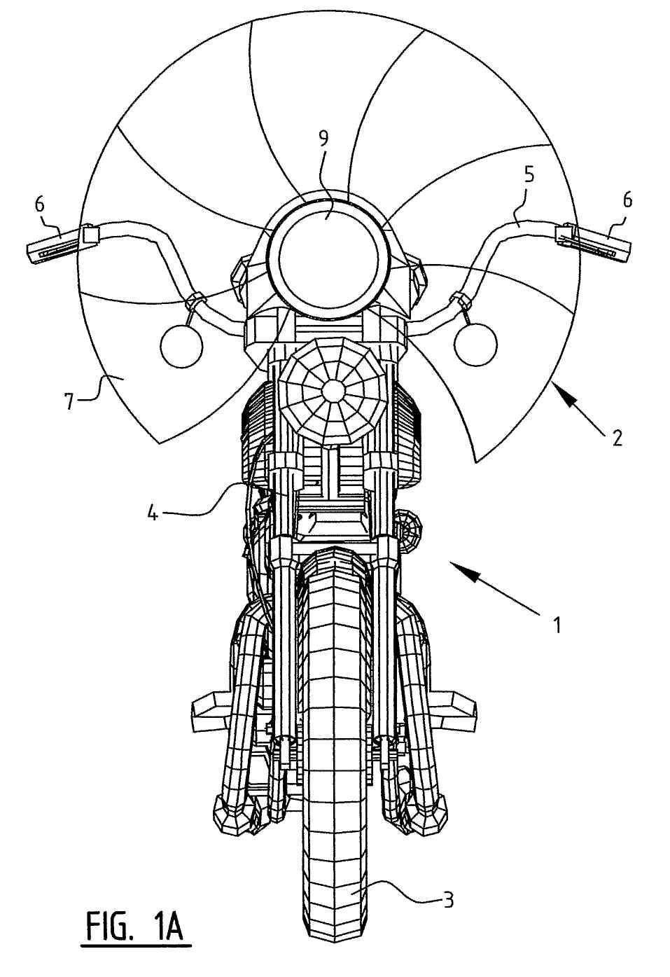

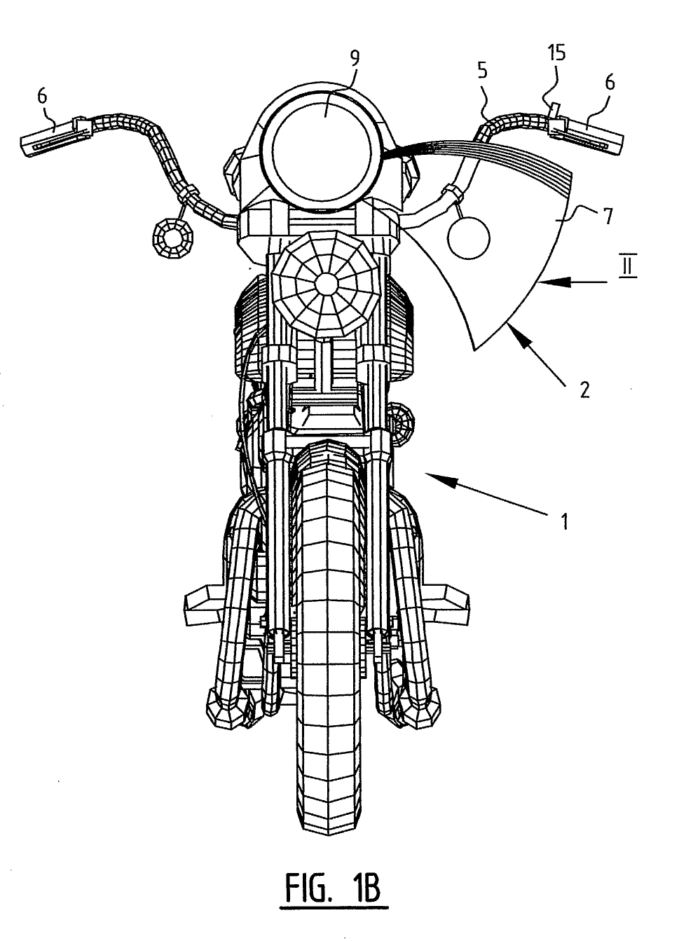

FIGS. 1A and 1B a first embodiment of the windshield according to the invention in the folded out and folded in mode, respectively.

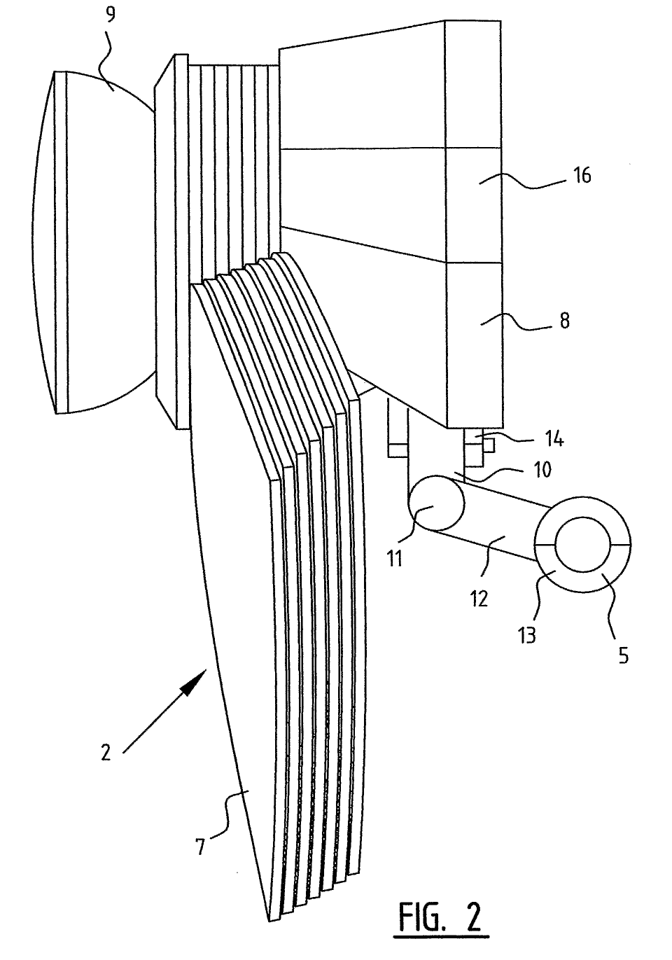

FIG. 2 at a different scale and schematic a side view according to arrow II in FIG. 1B; and

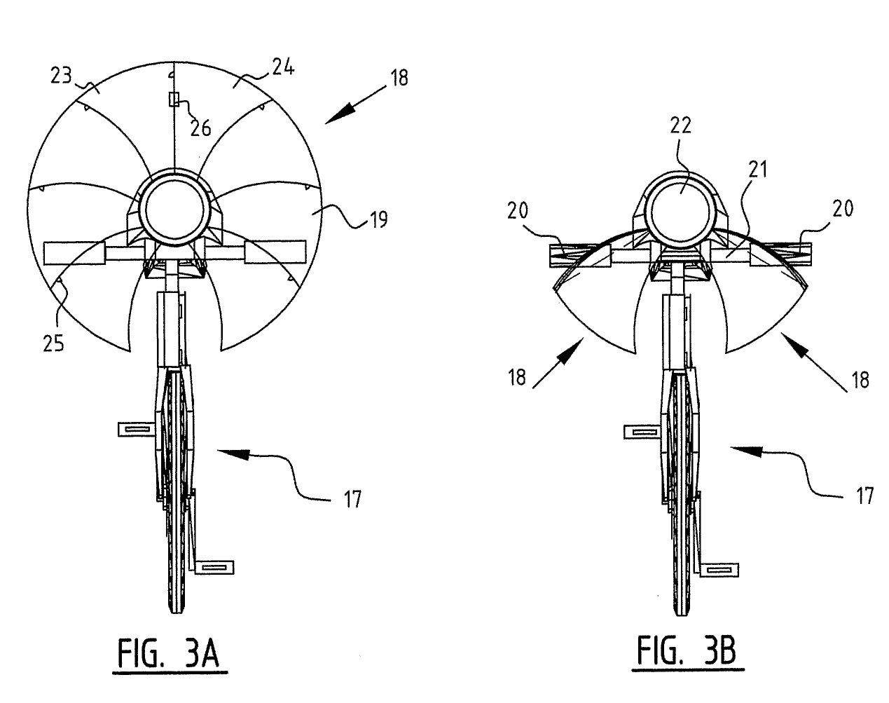

FIGS. 3A and 3B another embodiment of the windshield and vehicle according to the invention.

Referring to FIGS. 1 and 2, is shown a vehicle 1, a motorbike, provided with a windshield according to the invention.

The motorbike 1 is provided with a front wheel 3 mounted in a front steer fork 4 provided with a steering bar 5 and hand handles 6. The motorbike 2 is provided with the windshield 2 comprising a number of shield elements 7. In this embodiment the shield elements are seven in number.

FIG. 1B shows the windshield 2 in the folded in mode inwhich the shield elements 7 are grouped in a row below the hand handles of the steering bar 5.

FIG. 2 shows the windshield 2 in the folded in mode of FIG. 1B. The shield elements 7 are grouped in a row next to one another. The windshield comprises a frame 8 inwhich a rotational shaft (non shown) is rotatably mounted and carries the shield elements. The frame comprises further a head light 9. The frame 8 comprises two parallel bars 10 connected via a hinge 11 and a connecting bar 12 to the frame 13 of the motorbike, in this embodiment the steering bar 5. The bars 10 are provided with means 14 for adjusting the height of the windshield 2 relative to the vehicle, in this respect the steering bar 13. Accordingly, by adjusting the height with the means 14 for adjusting the height of the windshield 2 relative to the vehicle, in this respect the steering bar 13. Accordingly, by adjusting the height with the means 14 and the inclination position with the hinge 11, the windshield 2 according to the invention may be optimally positioned relative to the driver on the motorbike 2.

The steering bar 5 is provided with a switch 15 for actuating a motor 16 of the frame 8. This motor 16 is connected to the rotational shaft on which the shield elements are mounted. By actuating the motor 16 via the switch 15, the windshield 2 according to the invention may be folded out or folded in as desired by the driver. Electrical connections between the motor 16 or the head light 9 are not shown for reasons of convenience.

With reference to FIGS. 3A and 3B is shown another vehicle according to the invention, namely a bicycle 17. The bicycle 17 is provided with a windshield 18 according to the invention comprising eight shield elements according to the invention. The shield elements 19 are mounted on a common or two coaxial rotational shafts. The shield elements are divided in two groups. A first group is grouped in a row at the left side of the bicycle 17 and the other group is grouped in a row at the right side of the bicycle near the hand handles 20 of the steering bar 21. The bicycle is provided with a head light 22 mounted on the windshield according to the invention. In the folded out mode of the windshield the top shield elements overlap or abut thereby forming a windshield properly protecting the driver. In order to maintain the windshield according to the invention in the folded out mode, the rotational shaft or shafts may be arrested against undesired rotation or the shield elements may be provided with carry on elements 25 and/or with an arresting clamp or magnet 26 as desired for resting the folded out windshield in the position shown in FIG. 3a. Similar means may be provided for maintaining the folded in windshield in the positions shown in FIG. 3B or 3A.

1. Windshield for a vehicle, such as a motorbike or bicycle, comprising a frame connectable to said vehicle, which frame carries a shield comprising a number of shield elements foldably mounted to the frame.

2. Windshield according to claim 1, wherein the rotatable shield elements are mounted on a common rotation shaft.

3. Windshield according to claim 2, wherein the rotatable shield elements when folding in or out the windshield rotate in the same rotational direction.

4. Windshield according to claim 2, wherein the rotatable shield elements when folding in or out the windshield rotate in reverse rotational directions towards one another.

5. Windshield according to claim 2, comprising a motor connected to the rotational shaft for folding in or out the windshield elements.

6. Windshield according to claim 1, comprising means for adjusting the height dimension of the windshield relative to the vehicle.

7. Windshield according to claim 1, comprising a headlight.

8. Windshield according to claim 1, having the form of a circle.

9. Vehicle, such as a motorbike or bicycle comprising a windshield according to claim 1 connected to the vehicle.

10. Windshield according to claim 3, comprising a motor connected to the rotational shaft for folding in or out the windshield elements.

11. Windshield according to claim 4, comprising a motor connected to the rotational shaft for folding in or out the windshield elements.

12. Windshield according to claim 2, comprising means for adjusting the height dimension of the windshield relative to the vehicle.

13. Windshield according to claim 5, comprising means for adjusting the height dimension of the windshield relative to the vehicle.

14. Windshield according to claim 2, comprising a headlight.

15. Windshield according to claim 5, comprising a headlight.

16. Windshield according to claim 2, having the form of a circle.

17. Windshield according to claim 5, having the form of a circle.

18. Vehicle, such as a motorbike or bicycle comprising a windshield according to claim 2 connected to the vehicle.

19. Vehicle, such as a motorbike or bicycle comprising a windshield according to claim 5 connected to the vehicle.
